(19) United States
(12) Patent Application Publication
(10) Pub. No.: US 2007/0078985 A1
(43) Pub. Date: Apr. 5, 2007

(54) Method, system and computer program product for preventing illegal user from logging in

(76) Inventors: Ling Shao, Beijing (CN); Royd Yan, Beijing (CN); Juan Zhang, Beijing (CN)

Correspondence Address: ANNE VACHON DOUGHERTY, 3173 CEDAR ROAD, YORKTOWN HTS., NY, 10598, US

(21) Appl. No.: 11/455,143

(22) Filed: Jun. 16, 2006

(30) Foreign Application Priority Data
Jun. 16, 2005 (CN) 200510078917.4

(51) Int. Cl. G06F 15/16; G06F 15/173

(52) U.S. Cl. 709/226; 709/207

(57) ABSTRACT

A method for preventing an illegal user from logging in an online application with an authentic user's user log-in information is provided in the present invention. The system associates user log-in information with personal communication device information specified by the authentic user. In response to receiving the user log-in information inputted by a user, the system retrieves the personal communication device information associated with the user log-in information, and sends a short message to the personal communication device to notify the authentic user of the logging operation. If no confirming message is received from the authentic user, log in is rejected.

### FIELD OF THE INVENTION

The present invention relates to the field of online application, especially, a method, system and computer program product for preventing illegal user from logging on an online application with an authentic user's user ID and password.

### BACKGROUND OF THE INVENTION

In many online service applications, e.g., online network games, a user is identified by a unique Identifier/password (ID/PW). All the important data of the user are bounded to this ID/PW. For example, in the case of an online game, if the ID/PW is hacked, the user will lose his grade and all virtual assets. It is a disaster not only for the user but also for the online game service. Unfortunately, the ID/PW hacking is frequently carried out just by some simple methods, such as ‘Trojan Horse’. The hacker records the behavior of the user at the client side by recording all the keystroke actions of the user with virus programs such as ‘Trojan Horse’, obtains the user's ID/PW, then plays as the authentic user to steal the assets. The authentic user usually has no preparation for such theft for he does not know when it occurs.

Most online game users have encountered the inroad by an information stealer. Whether the password protection system of an online game is perfect and appropriate is becoming one of the most important factors influencing the choice of the game by game players.

Although some real time virus monitoring techniques, such as virus killing software, have been developed to prevent the information stealing activity by the virus, the capability of preventing information stealing in network games by virus killing software only can be enhanced by timely upgrading of the game version. Further, the real time monitoring system of the virus killing software can only identify a known Horse Virus which has been added into the virus database. When the virus author finds his virus exposed, he would usually modify his virus program and emit a new version in a short period. From the generation of the virus to the detection of the virus by the virus killer, from the detection of the virus to adding the virus into the virus database, from adding the virus to virus upgrading, there are a lot of time intervals. It is very possible that the game player's information would be lost during these time intervals.

In addition, the above real-time monitoring technique cannot resolve the problem of stealing the user ID and password with evil intent without relying on the network. When a player is playing an online game at a public site, he has to input his user ID and password first. And this kind of information may be watched and recorded by other players around him, resulting in the exposure of the information of his game account. Such a situation frequently occurs in public sites such as an Internet Cafe. Since this kind of stealing is not through a network, it can not be avoided from the technical perspective.

Therefore, there is a lack of an effective method and system in the prior art for preventing an illegal user from logging in to an online game with the illegally obtained user ID and password of an authentic user.

### SUMMARY OF THE INVENTION

The object of the present invention is not only preventing ‘Trojan Horse’-like hacking to user ID/password at the client side, but also preventing attempts to log in with the user ID and password obtained by other illegal ways.

To solve the above technical problems, the present invention provides a method for preventing an illegal user from logging in to an online application with an authentic user's user log-in information, the method comprising the steps of:

associating the user log-in information with personal communication device information specified by the authentic user;

in response to receiving the user log-in information inputted by a user, retrieving the personal communication device information associated with the user log-in information;

sending a short message to the personal communication device with the specified information to notify the authentic user of the logging operation;

inquiring if a confirming message in reply to the short message is received from the authentic user; and

if no confirming message is received from the authentic user, refusing logging in to the application with the user log-in information.

The present invention further provides a system for preventing an illegal user from logging in to an online. application with an authentic user's user log-in information, the system comprising:

processing means for associating the user log-in information with personal communication device information specified by the user and retrieving the associated personal communication device information according to the user log-in information;

storage means for storing the user log-in information and the associated personal communication device information;

first communication means for communicating with a client operated by the user;

second communication means for communicating with the personal communication device to send a short message to the personal communication device;

wherein, after the first communication means receives the user log-in information inputted from the client by the user, the processing means sends a short message to the personal communication device with the information associated with the user log-in information, through the second communication means, to notify the user of the logging operation, and refusing logging in the application with the user log-in information if no confirming message is received from the user by the first communication means or the second communication means.

The present invention further provides a computer program product, the computer program product containing computer readable program codes embodied in a computer readable storage medium that enables a computer system to implement a method of preventing an illegal user from logging in an online application with an authentic user's registration information.

The present invention uses an out-of-band personal device, such as a mobile phone, to realize the object of preventing illegal users from logging in. When a user logs in, the server will send a message to the user's registered mobile phone for confirmation. Only after a reply to the message is received will the service be started up by the server. Therefore, it is possible to prevent an illegal user from logging in an online application with an authentic user's log-in information and stealing the network assets of the authentic user.

The present invention is feasible and efficient since the mobile phone is very popular today, and the messaging fee is acceptable. Service providers also can use it as a value-added service to avoid extra service costs.

### BRIEF DESCRIPTION OF THE DRAWINGS

The present invention and it various objectives, features and advantages can be better understood by those skilled in the art with reference to the following accompanying drawings, where like reference numbers indicate similar or same element throughout the drawings, in which:

FIG. 1 is a block diagram for illustrating a system 100 for implementing an online game in the prior art;

FIG. 2 is a block diagram for illustrating a system 200 for implementing an online game according to an embodiment of the present invention, FIG. 3 is a flowchart for illustrating a method for preventing an illegal user's logging-in according to an embodiment of the present invention, and

FIG. 4 is a flowchart for illustrating the operation process when a user registers to an online game for the first time.

### DETAILED DESCRIPTION OF THE INVENTION

Now, the preferred embodiments of the present invention will be described in detail. It should be noted that, the description disclosed herein is merely illustrative and should not be intended to limit the present invention. On the contrary, with the teaching of the present invention, a person skilled in the field can make proper amendments and modifications to the present invention resulting in variations and equivalents thereof that fall into the scope of the invention as defined by the appended claims.

Meanwhile, it should be noted that, although an online game is described herein as an example, the person skilled in the art would appreciate that the present invention should not be limited only to a method and system for preventing an illegal user from logging in to an online game. In fact, the method and system according to the present invention is applicable to any online applications in which information such as user ID and password is required to verify the identity of the user, for preventing an illegal user's intrusion.

To make the present invention easier to be understood, a conventional online game system in the prior art is described first.

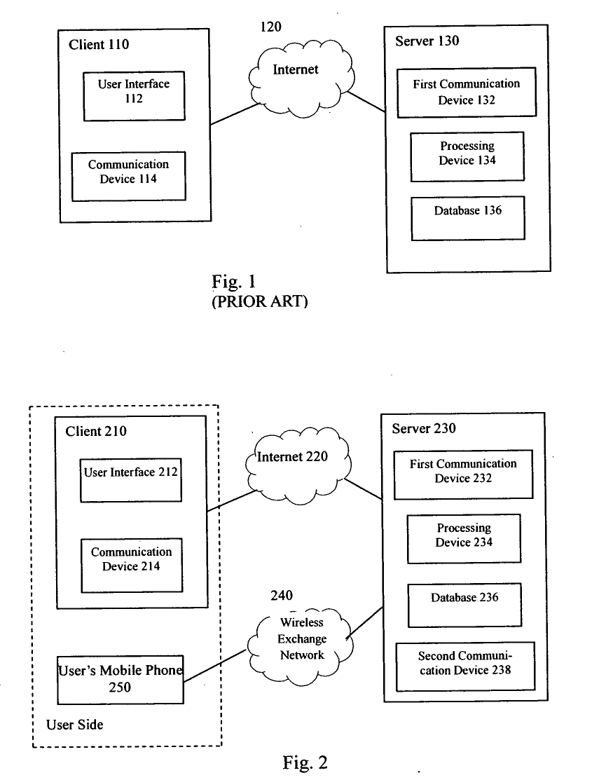

FIG. 1 is a block diagram illustrating a system 100 for implementing an online game in the prior art. The system 100 includes a client 110, Internet 120 and a server 130. The user operates at the client 110 side, inputs the information such as user ID and password via a user interface 112, and transmits the information such as user ID and password to the server 130 which is running the online game, through a communication device 114 via Internet 120. The server 130 communicates with the client 110 through a first communication device 132 via Internet 120, including receiving the information from the client 110 and sending information and instructions to the client 110. A processing device 134 processes the operations relating to the online game, including verifying user ID and password, etc. A database 136 is used for storing a variety of information relating to the online game, including user ID and password information, and a variety of information relating to the user ID.

It can be seen from the block diagram in FIG. 1 that, if an illegal user logs in to the online game with the authentic user's user ID and password, the current online game system could not prevent the illegal user from logging in, which would likely cause the loss of the authentic user's assets.

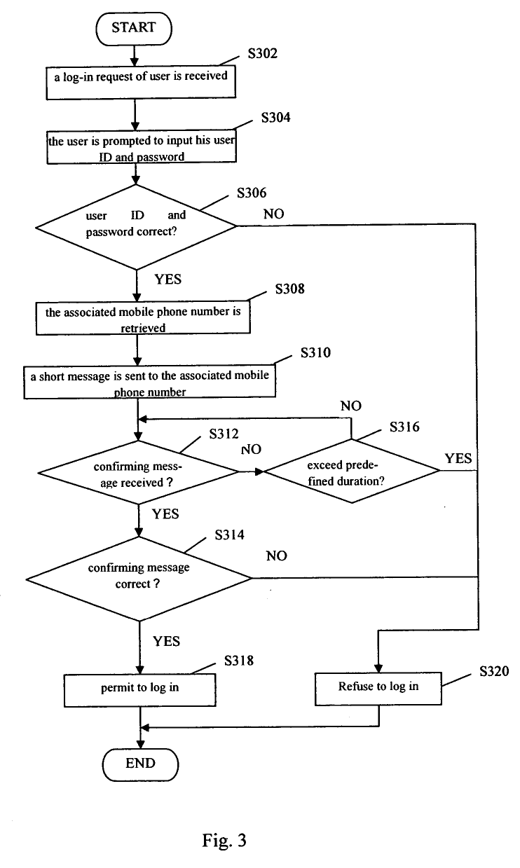

FIG. 2 is a block diagram illustrating a system 200 for implementing an online game according to an embodiment of the present invention. The system 200 includes a client 210, Internet 220, a server 230, a wireless communication network 240 and a user's mobile phone 250.

The client 210 includes a user interface 212 and a communication device 214. As in the prior art, the user inputs the user ID and password via the user interface 212, and transmits the user ID and password to the server 230 which is running the online game, through the communication device 214 via Internet 220. In the present invention, when the user registers with the online game for the first time, he is asked to input a mobile phone number which is desired to be associated with his user ID and password through the user interface 212. The user may also be asked to input a confirming message for confirming the log-in action through the user interface 212. Meanwhile, the user can change the mobile phone number and message associated with his user ID and password through the user interface 212. The above would be explained in detail in the following description.

The server 230 includes a first communication device 232, a processing device 234, a database 236 and a second communication device 238.

The server 230 communicates with the client 210 through the first communication device 232 via Internet 220, including receiving information from the client 210 and sending information and instructions to the client 210. The processing device 234 processes operations relating to the online game, including verifying user ID and password, etc.

The database 236 is for storing a variety of information relating to the online game, including user ID and password information, and a variety of information relating to the user ID. More importantly, mobile phone number information which is associated with the user ID and password is stored in the database 236. It should be noted that other storage devices can also be used to store the information relating to the online game, including user ID, password, mobile phone number information, etc., instead of the database.

The second communication device 238 communicates with a user mobile phone 250 which has an associated mobile phone number through the wireless communication network 240.

In the present invention, the processing device 234 associates the user ID and password with one or more mobile phone numbers in accordance with the received user input. When a user logs in to the online game with the user ID and password, the processing device 234 retrieves the mobile phone number stored in the database 236 and sends a short message to the user's mobile phone 250 through the second communication device 238, notifying the user of the log-in action. The processing device 234 verifies if it is the authentic user who is trying to log in according to the reply from the user's mobile phone 250 or the input from the user interface 212.

It should be noted that, although the above devices are described separately, a person skilled in the art will understand that, those devices not only can be implemented in different elements, but also can be implemented in a single element.

Furthermore, it should be noted that, although a mobile phone is described herein as an example, the present invention shall not be limited to the mobile phone. Any personal communication device which can communicate with the server can be used to implement the present invention, including personal digital assistance, pager, or even wired telephone, by associating its number with the user ID and password.

FIG. 3 is a flowchart illustrating a method for preventing an illegal user from logging in according to an embodiment of the present invention. At Step S302, a log-in request is received from a user. At Step S304, the user is prompted to input his user ID and password. At Step S306, it is verified if the inputted user ID and password are correct. If YES, the process proceeds to Step S308. Otherwise, the process proceeds to Step S320, where the user is rejected to log in.

At Step S308, the associated mobile phone number is retrieved according to the user ID and password input by the user. The mobile phone number was associated with the user ID and password when the user registered the first time. At Step S310, a short message is sent to the associated mobile phone number to notify the user about the above log-in action. Then, at Step S312, the process waits to see if there is a confirming message received from the user. If the confirming message is received, the process proceeds to Step S314. Otherwise, the process proceeds to Step S316. At Step S316, if the waiting time exceeds a predefined duration, the process proceeds to Step S320, where the user is rejected to log in. If the waiting time does not exceed the predefined duration at Step S316, the process goes back to Step S312 to wait for the reply from the user.

At Step S314, it is verified if the received confirming message is correct. If YES, the process proceeds to Step S318, where the user is permitted to log in. If No, the process proceeds to Step S320, where the user is rejected to log in.

According to an embodiment of the present invention, when the user receives a short message sent to the associated mobile phone by the server, he can reply with a short message for confirming to the server directly with this mobile phone. After receiving the short message replied from this mobile phone, the server will verify the received confirming message. In such a circumstance, there may be no change in the user interface of the client, or there may be a piece of information in the user interface of the client to prompt the user to reply a message with the mobile phone. If it is an illegal user that is attempting to log in with another authentic user's ID and password, the illegal user would be prevented from logging in with the authentic user's ID and password, since he could not send a message with the associated mobile phone.

In such a circumstance, the confirming message can simply be “YES”. The confirming message may also contain the ID information to distinguish different IDs of one user. Further, to guarantee the security, the confirming message should also contain some random information. Therefore, the confirming message can be a kind of combination of ID information and random information. The server may generate some random information and combine the generated random information with the user's ID information to be sent to a mobile phone.

According to another embodiment of the present invention, when the server sends a short message to the associated mobile phone, a dialog box for inputting the confirming message would pop up on the user's client, asking the user to input the confirming message into the dialog box based on the short message received by the associated mobile phone. The server then verifies the user's authenticity according to the confirming message input by the user. Since an illegal user could not obtain the short message received by the associated mobile phone, he could not input the confirming message correctly, thereby the illegal user is prevented from logging in with an authentic user's ID and password.

In such conditions, the confirming message should not be replied simply with “YES”, but needs to be related to the short message sent by the server. This message may contain the user's ID information and random information generated by the server. For example, when the user receives the short message, the random information in the short message may be considered as a “confirmation number”. The user may send this confirmation number to the server so as to resume the logging process by entering the number in the confirmation dialog box, instead of replying with a message via the mobile phone.

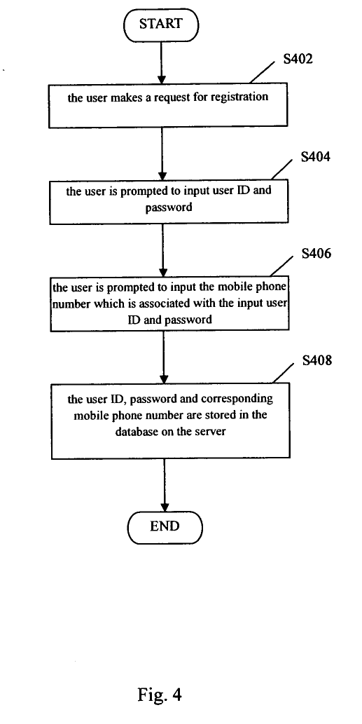

The association of the mobile phone number with the user ID and password can be conducted when the user registers with the online game for the first time. FIG. 4 is a flowchart for illustrating the operation process when a user registers to an online game for the first time. Firstly, at Step S402, the user makes a request for registration. At Step S404, the user is prompted to input user ID and password. At Step S406, the user is prompted to input the mobile phone number which is associated with the input user ID and password. At Step S408, the user ID, password and corresponding mobile phone number are stored in the database on the server for future log-in use by the user.

If the user wants to change the associated mobile phone number, he/she must confirm this action with both user ID/PW and the original mobile phone number. Firstly, the user needs to log in to the online game with user ID and password information. Of course, this process needs to be confirmed with the short message sent by the mobile phone. Then the user can enter the mobile phone number to change the associated mobile phone number, thereby preventing a hacker from tampering with the mobile phone number registered by the user.

According to an embodiment of the present invention, the user can have several different user IDs/PWs in one online game. Those several different user IDs/PWs can be associated with a mobile phone number, respectively. Those mobile phone numbers can be same or different.

Furthermore, the user can associate one user ID/PW with more than two mobile phone numbers. For example, the user may associate his/her own phone number and his/her family or friends’ phone numbers with his/her user ID/PW to ensure he/she can receive the message in time. Furthermore, the user may establish an order of priority for the phone numbers as required when he associates those numbers with the phone. When the server receives a log-in request, it sends short messages to those phone numbers successively. For example, the server first sends the short message to the phone numbers with first priority level. If no confirming message is received within a predefined period, the server then sends the short message to the phone numbers with second priority level. The server will not cease sending the short message to successive priority levels until a confirming message is received. According to another embodiment of the present invention, the server may also send the short message to several phone numbers at the same time as the user requires, in order to ensure that the user can receive the short message via different paths as soon as possible. Certainly, this option needs to be chosen by the user in consideration of time and cost.

Next, we use an online game as an example to describe a typical process.

Grace has two IDs in an online game. She registers them as ID-a/PW-a/Mobile phone-a and ID-b/PW-b/Mobile phone-b. The PW-a/PW-b, Mobile phone-a/Mobile phone-b are not necessarily different. She uses ID-a/PW-a to log in. When she types in the ID-a/PW-a, the server sends a message to her mobile phone with the number ‘Mobile phone-a’. The message can be a random sequence to indicate that ID-a is being used. Because Grace is the authentic user, she can receive this message and reply it with the mobile phone she is carrying. For example, she can reply with the same sequence to confirm her request. After confirming, the game playing starts up really.

If a hacker pretends to be Grace by using ID-b/PW-b to log in, the server will send a message to the mobile phone of the number ‘Mobile phone-b’. Since the hacker does not have this mobile phone actually, he cannot reply to the message. But Grace is able to receive this message and know that someone else is trying to use ID-b/PW-b to log in. Then she can inform the server to block the logging in. Therefore the hacking is prevented.

Thus, even if an illegal user can log in the online game as an authentic user by using other ways, the authentic user may also receive the notification via the mobile phone and become aware that someone else is attempting to log in the game with his/her identity. At this moment, the authentic user can inform the server to block the logging in or use, thereby preventing the hacking.

While preferred embodiments of the present invention have been described mainly with respect to a hardware structure or method steps in the above, the operation method of the system according to the present invention may also be implemented as computer program software. For example, the method according to an exemplary embodiment of the present invention can be embodied as a computer program product, which enables a computer to execute one or more exemplified methods. The computer program product may comprise a computer readable medium containing computer program logic or codes thereon for enabling the system to execute according to one or more exemplified methods.

The computer readable storage medium can be a built-in medium in the computer body or a movable medium that can be arranged so that it can be detached from the computer body. Examples of the built-in medium include, but are not limited to, a rewritable non-volatile memory, such as an RAM, an ROM, a flash memory and a hard disk. Examples of the movable medium include, but are not limited to, an optical media such as CD-ROM and DVD; a magneto-optic storage media such as MO; a magnetic storage media such as a floppy disk (trademark), a cassette and a movable hard disk; and a media with a built-in ROM such as an ROM box.

The program of the method according to the present invention can also be provided in the form of externally provided broadcast signals and/or computer data signals included in a carrier wave. The computer data signals embodied as one or more instructions or functions of the exemplary method can be carried on the carrier wave sent and/or received by the entity for executing the instructions or functions of the exemplary method. Moreover, such a program can be stored and distributed easily when recorded on a computer readable storage media.

The above description is only illustrative substantially. Therefore, any changes without departing from the essence of the present invention are intended to be within the scope of the present invention. Such changes are not considered as departing from the spirit and scope of the present invention.

1. A method for preventing an illegal user from logging in to an online application with an authentic user's user log-in information, the method comprising the steps of:
associating the user log-in information with personal communication device information for at least one personal communication device specified by the authentic user;
in response to receiving the user log-in information inputted by a user, retrieving the personal communication device information associated with the user log-in information;
sending a message to at least one personal communication device with the specified information to notify the authentic user of the logging operation;
inquiring if a confirming message in reply to the message is received from the authentic user; and
if no confirming message is received from the authentic user, refusing logging in to the application with the user log-in information.

2. The method of claim 1, wherein the user log-in information includes user ID and password.

3. The method of claim 1, wherein the personal communication device information includes the number for contacting the at least one personal communication device.

4. The method of claim 1, wherein the message sent to the personal communication device with the specified information includes the user log-in information and some random information.

5. The method of claim 1, further comprising the steps of:
when the confirming message is received from the user, verifying if the confirming message is correct,
if the confirming message is correct, allowing logging in the online application with the user log-in information;
if the confirming message is not correct, rejecting logging in the online application with the user log-in information.

6. The method of claim 1, wherein, the step of inquiring if a confirming message in reply to the message is received from the authentic user further comprises the step of:
inquiring if a confirming message replied by the personal communication device in the form of a predetermined message is received.

7. The method of claim 6, wherein, if the confirming message replied by the personal communication device in the form of a predetermined message is “YES”, allowing logging in to the online application with the user log-in information.

8. The method of claim 6, wherein, the confirming message replied by the personal communication device in the form of a predetermined message contains ID information received by the personal communication device.

9. The method of claim 6, further comprising the steps of:
verifying the received confirming message replied by the personal communication device in the form of a predetermined message,
if the confirming message is correct, allowing logging in to the online application with the user log-in information;
if the confirming message is not correct, refusing logging in to the online application with the user log-in information.

10. The method of claim 1, wherein, after sending a message to the personal communication device with the specified information, sending to the user's client an indication prompting input of confirming message,
wherein the step of inquiring if a confirming message to the message is received from the authentic user further comprises the step of inquiring if a confirming message inputted from the client is received.

11. The method of claim 10, further comprising the steps of:
verifying the received confirming message inputted from the client,
if the confirming message is correct, allowing logging in to the online application with the user log-in information;
if the confirming message is not correct, rejecting logging in to the online application with the user log-in information.

12. The method of claim 11, wherein, the confirming message inputted from the client comprises the information contained in the message received by the personal communication device.

13. The method of claim 1, wherein, the personal communication device is a mobile telephone.

14. A system for preventing an illegal user from logging in to an online application with an authentic user's user log-in information, the system comprising:
processing means for associating the user log-in information with personal communication device information for at least one personal communication device specified by the user and retrieving the associated personal communication device information according to the user log-in information;
storage means for storing the user log-in information and the associated personal communication device information;
first communication means for communicating with a client operated by the user;
second communication means for communicating with at least one personal communication device to send a message to the personal communication device;
wherein, after the first communication means receives the user log-in information inputted from the client by the user, the processing means sends a message to the at least one personal communication device with the information associated with the user log-in information, through the second communication means, to notify the user of the logging operation, and refusing logging in the application with the user log-in information if no confirming message is received from the user by the first communication means or the second communication means.

15. The system of claim 14, wherein the user log-in information includes user ID and password.

16. The system of claim 14, wherein the personal communication device information includes at least one number for contacting the at least one personal communication device.

17. The system of claim 14, wherein the message sent to the personal communication device with the specified information includes user log-in information and some random information.

18. The system of claim 14, wherein the processing means verifies if the confirming message received from the user is correct,
if the confirming message is correct, allowing logging in to the online application with the user log-in information;
if the confirming message is not correct, rejecting logging in to the online application with the user log-in information.

19. The system of claim 14, wherein the processing means inquires if a confirming message replied by the personal communication device in the form of a predetermined message is received.

20. The system of claim 14 wherein, after the second communication means sends a message to the personal communication device with the specified information, the processing means sends to the user's client an indication prompting input of a confirming message,
wherein, the processing means inquires if a confirming message inputted from the client is received.

21. The system of claim 20, wherein, the processing means verifies the received confirming message inputted from the client,
if the confirming message is correct, allowing logging in to the online application with the user log-in information;
if the confirming message is not correct, rejecting logging in to the online application with the user log-in information.

22. The system of claim 20, wherein, the confirming message inputted from the client comprises the information contained in the message received by the personal communication device.

23. The system of claim 14, wherein, the personal communication device is a mobile telephone.

24. A computer program product, the computer program product containing computer readable program codes embodied in a computer readable storage medium that enables a computer system to implement the method of claim 1.
